(19) United States
(12) Patent Application Publication
(10) Pub. No.: US 2013/0075540 A1
(43) Pub. Date: Mar. 28, 2013

(54) MULTIPLE POSITION PIPE HANGER CLAMP

(71) Applicants: John Hammond, Brisbane (AU); Francesco Tomasi, Brisbane (AU)

(72) Inventors: John Hammond, Brisbane (AU); Francesco Tomasi, Brisbane (AU)

(73) Assignee: SITKA DEVELOPMENTS PTY LTD, BRISBANE, QN (AU)

(21) Appl. No.: 13/577,018

(22) PCT Filed: Feb. 3, 2011
(86) PCT No.: PCT/AU2011/000105

§ 371 Date: Dec. 6, 2012

(30) Foreign Application Priority Data
Feb. 4, 2010 (AU) 2010900656
Aug. 13, 2010 (AU) 2010903640
Nov. 12, 2010 (AU) 2010905058

(51) Int. Cl. F16L 3/12

(52) U.S. Cl. CPC F16L 3/12
USPC 248/62

(57) ABSTRACT

A multiple position pipe hanger clamp (800) enables more efficient installation of piping. The clamp (800) includes a support member (825) and an upper clamp component (810) attached to the support member (825). A first section extends away from the support member (825) to an upper hinge end (815) and a second section extends away from the support member (825) to an upper tightening end. A lower clamp component (805) includes a lower hinge end (820) and a lower tightening end. A multiple position clamp mechanism (830) clamps the lower tightening end to the upper tightening end. The upper hinge end (815) is hingedly attached to the lower hinge end (820), and the clamp mechanism (830) is movable between a loose position that supports the lower tightening end loosely adjacent the upper tightening end, and a tight position that supports the lower tightening end tightly adjacent the upper tightening end.

### FIELD OF THE INVENTION

The present invention relates to pipe hangers. In particular, the invention relates to a multiple position pipe hanger clamp including a hinge side and a multiple position clamp side.

### BACKGROUND TO THE INVENTION

Pipe and tube hangers are well known in the art for suspending various types of pipes, tubes, conduit and cabling above the ground. For example, water and sewerage pipes are commonly suspended below floor joists using spaced hangers.

Referring to FIG. 1, a diagram illustrates a perspective view of a typical pipe hanger 100 used primarily in residential construction, and well known according to the prior art. The pipe hanger 100 includes a sheet metal support strap 105 that is connected to an upper semi-circular clamp member 110. In use the support strap 105 is typically nailed or screwed to a floor joist (not shown) of a building such that the upper semi-circular clamp member 110 is suspended just below the floor joist. A pipe (not shown) is then positioned against the upper semi-circular clamp member 110. Next, a lower semi-circular clamp member 115 is positioned underneath the pipe. Two bolts 120 and two nuts 125 are then used to secure the pipe between the upper semi-circular clamp member 110 and the lower semi-circular clamp member 115 and suspend the pipe securely above the ground.

However, the prior art pipe hanger 100 as illustrated in FIG. 1 can be awkward and tedious to use, particularly on large construction jobs where dozens or even hundreds of the pipe hangers 100 are often assembled and installed over a short time period. For example, the pipe hangers 100 are often provided in boxes that include an exact count of the bolts 120 and nuts 125 needed for all the hangers 100 in the box. Thus losing bolts 120 or nuts 125 can be problematic. Further, assembling the bolts 120 and nuts 125 on either side of a pipe, while holding the pipe and the lower semi-circular clamp member 115 in position can be awkward and difficult.

Other types of prior art pipe hangers include the following:

U.S. Pat. No. 7,325,776 describes a suspensory fastener for piping that includes a long band and a short band. A lower end coupling portion of the long band is engaged with an opening with a guiding entrance, enabling release of the coupling portion without disassembly of a bolt and nut set used to hold the two bands together.

US Patent Publication No. 2005/0205722 describes a pipe and tube support that includes a housing having upper and lower housing portions that are hingedly interconnected to provide a clam-shell like configuration. An interconnection is provided between the housing and a support rod and allows the housing to be at an angle to accommodate a sloped pipe or tube.

US Patent Publication No. 2004/0026575 describes a fastener for laying pipes having a two-section band, where both sections are joined with a single bolt directly beneath a pipe.

US Patent Publication No. 2008/0011908 describes a hanger clamp with hanger strap that includes a top portion that has a channel for receiving a rod therethrough and a bottom strap portion that supports a pipe. Ends of the bottom strap are fastenerlessly connected to the top portion on opposite sides of the top portion by fitting into slots or notches in the top portion.

U.S. Pat. No. 4,557,447 describes a pipe clamp having two clamp segments held together by a bridge piece. The bridge piece features interlocking segment ends. Opposite the bridge piece, a tensioning member is used to tighten the pipe clamp using back-to-back bolts.

U.S. Pat. No. 6,131,859 describes a pipe clamping apparatus including first and second arcuate wings, where the wings are joined by a hinge. End portions of the wings include through-holes and screws for joining the wings together.

U.S. Pat. No. 5,133,523 describes a suspendable conduit bracket lock system including a back bracket and an externally protruding radial portion including elements for selectable lockable engagement with a longitudinal segment.

However, the above described prior art hangers also generally have one or more disadvantages related to easily dropped or lost bolts and nuts, poor strength, or difficulty with adjustments. There is therefore a need for an improved multiple position pipe hanger clamp.

### OBJECTS OF THE INVENTION

Therefore, an object of the present invention is to overcome or alleviate one or more limitations of the prior art, including providing an improved multiple position pipe hanger clamp.

### SUMMARY OF THE INVENTION

According to one aspect, the present invention is a multiple position pipe hanger clamp. The pipe hanger clamp comprises:

a support member;

an upper clamp component attached to the support member, the upper clamp component including a first section extending away from the support member to an upper hinge end and a second section extending away from the support member to an upper tightening end;

a lower clamp component having a lower hinge end and a lower tightening end, wherein when the upper clamp component is assembled adjacent the lower clamp component they define a diameter of the pipe hanger clamp; and

a multiple position clamp mechanism for clamping the lower tightening end to the upper tightening end;

wherein the upper hinge end is hingedly attached to the lower hinge end, and the clamp mechanism is movable between a loose position that supports the lower tightening end loosely adjacent the upper tightening end, and a tight position that supports the lower tightening end tightly adjacent the upper tightening end; and

wherein when the upper tightening end is separated from the lower tightening end and the lower hinge end remains connected to the upper hinge end, or when the upper hinge end is separated from the lower hinge end and the upper tightening end remains connected to the lower tightening end, an opening is formed between the upper tightening end and the lower tightening end, or respectively between the upper hinge end and the lower hinge end, which opening is equal to or greater than the diameter of the pipe hanger clamp.

Optionally, the upper and lower clamp components each comprise an arcuate loop of wire.

Optionally, the upper and lower clamp components comprise wire.

Optionally, the lower clamp component comprises a strap.

Optionally, the upper hinge end is slidably removable from the lower hinge end when the upper tightening end is detached from the lower tightening end.

Optionally, the upper hinge end is slidably removable from the lower hinge end when the clamp mechanism is in a loose position.

Optionally, the multiple position clamp mechanism comprises an over-centre buckle.

Optionally, the support member comprises a forked distal end.

Optionally, the support member is rotatably attached to the upper clamp component.

Optionally, the pipe hanger clamp further comprises a tamper resistant bendable tab adapted to be bent, after installation of the pipe hanger clamp, to prevent the upper hinge end from separating from the lower hinge end.

Optionally, the pipe hanger clamp further comprises a tamper resistant bendable tab adapted to be bent, after installation of the pipe hanger clamp, to prevent the multiple position clamp mechanism from opening from the tight position to the loose position.

Optionally, the pipe hanger clamp further comprises a tamper resistant bendable tab adapted to be bent, after installation of the pipe hanger clamp, to prevent the lower hinge end from separating from the upper hinge end.

Optionally, the upper clamp component and the lower clamp component are each semi-circular.

Optionally, the upper clamp component and the lower clamp component each comprise a single length of wire bent to define two substantially parallel semi-circular arcs.

Optionally, the upper clamp component and the lower damp component are integrally fabricated from a single piece of material.

Optionally, the upper clamp component and the lower clamp component are integrally fabricated from a single length of wire.

Optionally, a distal end of the upper tightening end of the upper clamp component is bent and protrudes through a single slot in the centre of the multiple position clamp mechanism.

Optionally, the upper clamp component and the lower clamp component together comprise a single length of wire bent to define two substantially circular sections that are substantially parallel.

Optionally, the upper and lower clamp components comprise sheet metal.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 is a diagram illustrating a perspective view of a typical pipe hanger, as known according to the prior art;

FIG. 2 is a diagram illustrating a perspective view of a multiple position pipe hanger clamp, according to an embodiment of the present invention;

FIG. 3 is a diagram illustrating a further perspective view of the multiple position pipe hanger clamp of FIG. 2 shown supporting a pipe;

FIG. 4 is a diagram illustrating a perspective view of a multiple position pipe hanger clamp, according to an alternative embodiment of the present invention;

FIG. 5 is a diagram illustrating a perspective view of the multiple position pipe hanger clamp of FIG. 4 in an assembled configuration;

FIG. 6 is a diagram illustrating a perspective view of a multiple position pipe hanger clamp, according to another alternative embodiment of the present invention;

FIG. 7 is a diagram illustrating a perspective view of a final clamped configuration of the clamp shown in FIG. 6;

FIG. 8 is a diagram illustrating a rear perspective view of a multiple position pipe hanger clamp, according to another alternative embodiment of the present invention;

FIG. 9 is a diagram illustrating a further rear perspective view of the multiple position pipe hanger clamp shown in FIG. 8;

FIG. 10 is a diagram illustrating a side perspective view of the multiple position pipe hanger clamp shown in FIG. 8;

FIG. 11 is a diagram illustrating a front perspective view of a multiple position pipe hanger clamp, according to still another embodiment of the present invention;

FIG. 12 is a diagram illustrating another front perspective view of the multiple position pipe hanger clamp shown in FIG. 11;

FIG. 13 is a diagram illustrating a front perspective view of a multiple position pipe hanger clamp, according to still another embodiment of the present invention; and

FIG. 14 is a diagram illustrating a front perspective view of a multiple position pipe hanger clamp, according to still another embodiment of the present invention.

FIG. 15 is a diagram illustrating a perspective view of the multiple position pipe hanger clamp of FIG. 13 in an open configuration, and a section of pipe.

FIG. 16 is a diagram illustrating a perspective view of the multiple position pipe hanger clamp of FIG. 13 in a closed configuration around a section of pipe.

FIG. 17 is a diagram illustrating a side perspective view of a multiple position pipe hanger clamp, according to another alternative embodiment of the present invention.

FIG. 18 is a diagram illustrating an underside view of the multiple position pipe hanger clamp of FIG. 17.

FIG. 19 is a diagram illustrating a side view of the multiple position pipe hanger clamp of FIG. 17.

FIG. 20 is a diagram illustrating a side perspective view of a multiple position pipe hanger clamp, according to yet another alternative embodiment of the present invention.

FIG. 21 is a diagram illustrating an underside view of the multiple position pipe hanger clamp of FIG. 20.

FIG. 22 is a diagram illustrating another side perspective view of the multiple position pipe hanger clamp of FIG. 20.

FIG. 23 is a diagram illustrating a side perspective view of a multiple position pipe hanger clamp, according to still another alternative embodiment of the present invention.

FIG. 24 is a diagram illustrating a side view of the multiple position pipe hanger clamp of FIG. 23.

FIG. 25 is a diagram illustrating another side perspective view of the multiple position pipe hanger clamp of FIG. 23.

Those skilled in the art will appreciate that minor deviations from the symmetrical layout of components as illustrated in the drawings will not detract from the proper functioning of the disclosed embodiments of the present invention.

### DETAILED DESCRIPTION OF THE INVENTION

Embodiments of the present invention comprise a multiple position pipe hanger clamp. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, upper and lower, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

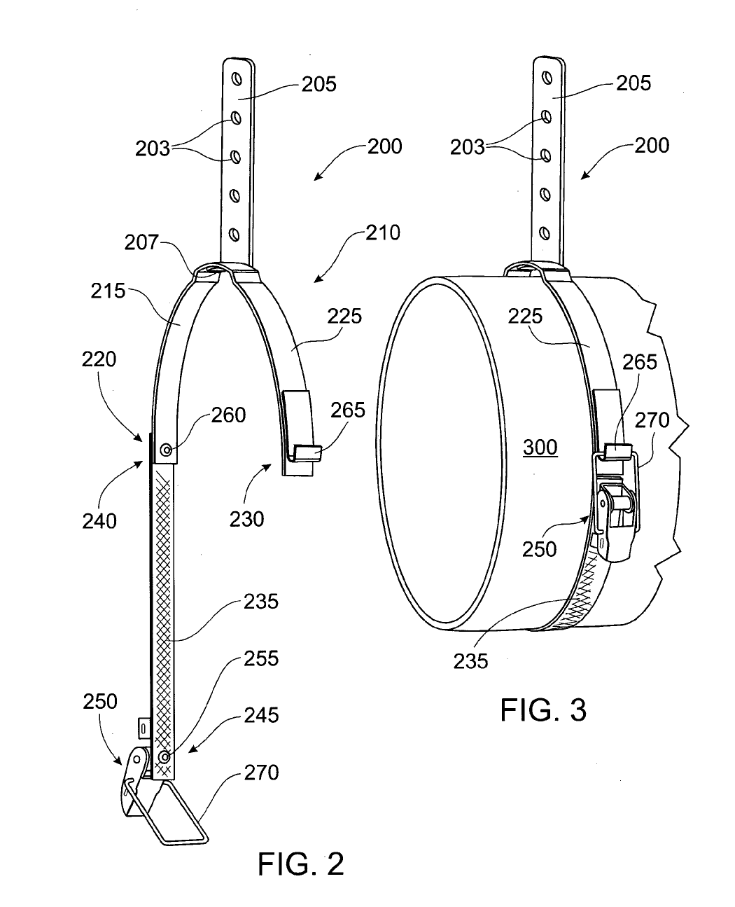

Referring to FIG. 2, a diagram illustrates a perspective view of a multiple position pipe hanger clamp 200, according to an embodiment of the present invention. The clamp 200 includes a support member 205 having holes 203. A semi-circular upper clamp component 210 is attached to the support member 205 at a weld junction 207. The upper clamp component 210 includes a first sheet metal section 215 extending away from the support member 205 to an upper hinge end 220 and a second sheet metal section 225 extending away from the support member 205 to an upper tightening end 230. A lower clamp component in the form of a strap 235 includes a lower hinge end 240 and a lower tightening end 245. The lower hinge end 240 of the strap 235 is attached to the upper hinge end 220 using a rivet 260.

The strap 235 can be made of various materials, such as sheet metal or a durable polymer. Also, those skilled in the art will appreciate that the upper clamp component and all other parts of the clamp 200 can comprise various alternative materials such as composites, various plastics, or polyvinyl chloride (PVC).

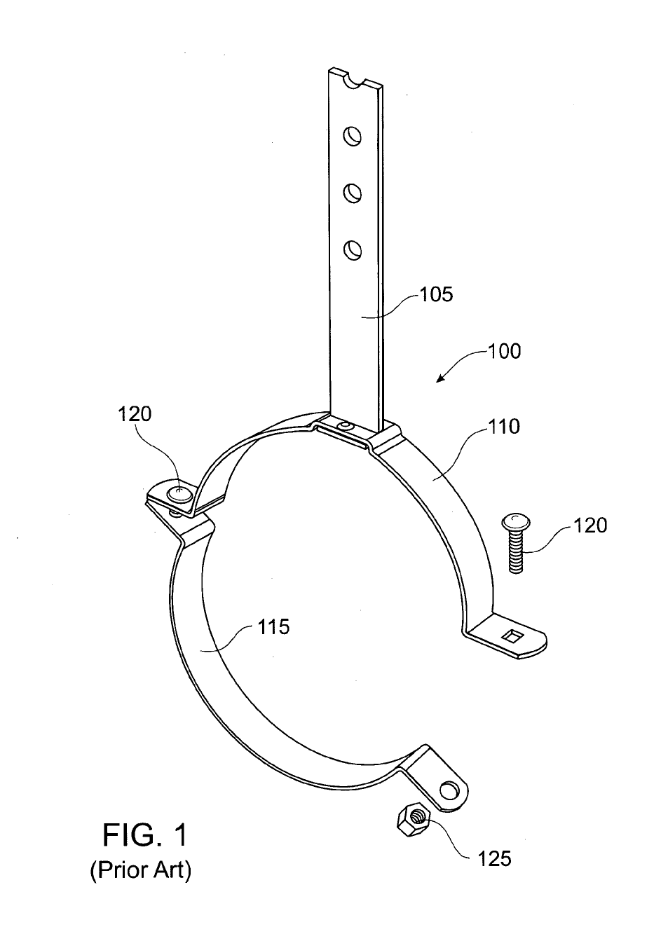

A multiple position clamp mechanism in the form of an over-centre buckle 250 is attached to the lower tightening end 245 using a rivet 255. A clasp 265 is welded to the upper tightening end 230. In use, a link 270 of the buckle 250 is received in the clasp 265. That provides a first loose position for supporting a pipe (not shown in FIG. 1) between the strap 235 and the upper clamp component 210.

Referring to FIG. 3, a diagram illustrates a further perspective view of the multiple position pipe hanger clamp 200 supporting a pipe 300. During construction work, the support member 205 is nailed to a joist or other support structure using the holes 203. Alternatively, those skilled in the art will recognize that the support member 205 can be replaced by various other types of support members, such as a “booker rod” (e.g., a 12 mm threaded rod) that can be fixed to the underside of a concrete slab.

The pipe 300 is then positioned below and adjacent the upper clamp component 210. Next, the strap 235 is wrapped around the pipe 300. The link 270 then can be received in the clasp 265 to first support the pipe 300 in a loose position.

After a final position of the pipe 300 is determined, the buckle 250 can be closed to secure the pipe 300 in a final tight position. As known by those having ordinary skill in the art, various types of securing mechanisms then can be used to ensure that the buckle 250 does not inadvertently or easily open. For example, a lock screw (not shown) can be inserted through the buckle 250, or a retaining clasp (not shown) can be snapped over the buckle 250. Alternatively, the clasp 265 can be simply crimped against the upper tightening end 230 so that the link 270 is locked in the clasp 265. According to yet another embodiment, a handle of the buckle 250 can be simply removed so that a tool such as a screwdriver is required to close and open the buckle. That can reduce the chances of the buckle 250 opening inadvertently.

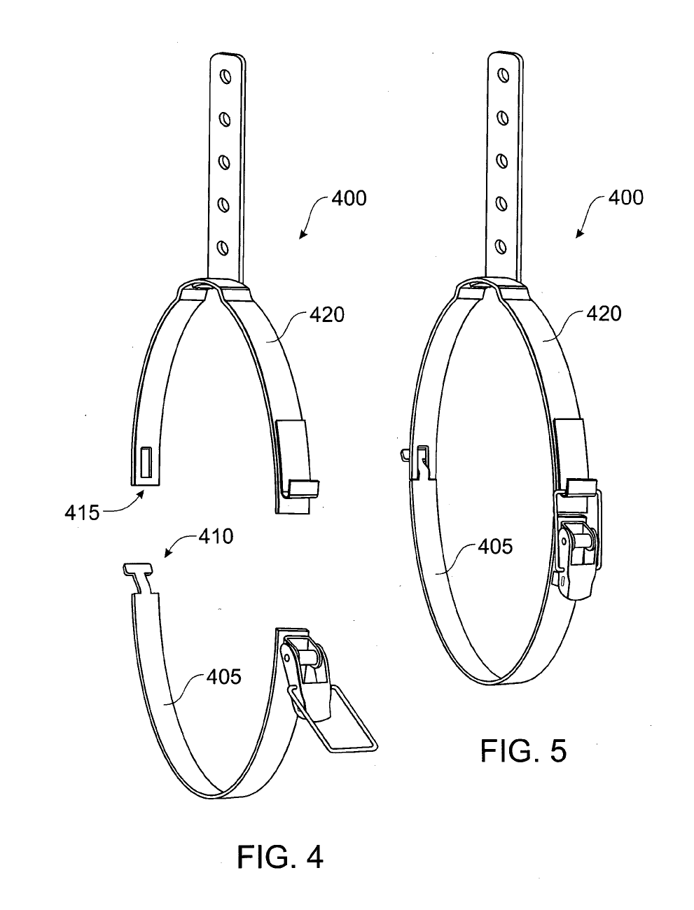

Referring to FIG. 4, a diagram illustrates a perspective view of a multiple position pipe hanger clamp 400, according to an alternative embodiment of the present invention. The clamp 400 is similar to the clamp 200; however, in the clamp 400 the strap 235 is replaced with a sheet metal lower clamp component 405. Further, a T-section 410 and a slot 415 enable a hinged connection between the lower clamp component 405 and an upper clamp component 420.

Referring to FIG. 5, a diagram illustrates a perspective view of the multiple position pipe hanger clamp 400 in an assembled configuration.

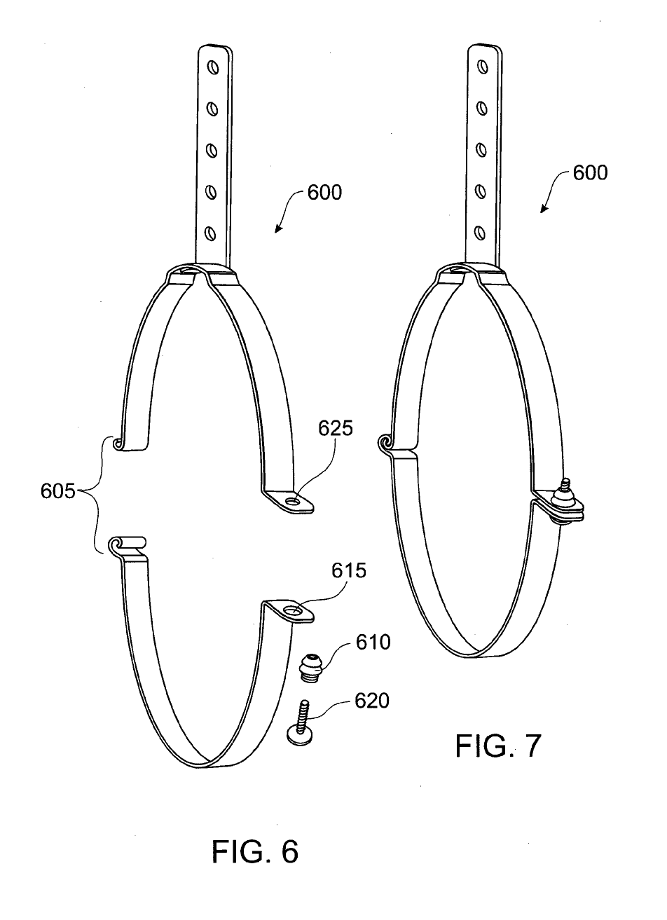

Referring to FIG. 6, a diagram illustrates a perspective view of a multiple position pipe hanger clamp 600, according to an alternative embodiment of the present invention. The clamp 600 is similar to the clamp 400; however, in the clamp 600 an alternative coiled metal hinge mechanism 605 is used to secure an upper hinge end and a lower hinge end. Also, a polymer mushroom connector 610 is used to secure together a lower tightening end and an upper tightening end. For example, a lower end of the mushroom connector 610 can be fit through a hole 615 in a lower tightening end of the clamp 600 and a screw 620 can be partially threaded into an opening on an underside of the mushroom connector 610. Such secure attachment of the mushroom connector 610 and the screw 620 to the clamp 600 can be performed before arriving on a job site, and thus eliminates a risk of dropping and losing the mushroom connector 610 and screw 620.

In use, upper and lower ends of the coiled metal hinge mechanism 605 are slid together and a pipe can be secured in the clamp 600 by pushing the mushroom connector 610 through a hole 625 in an upper tightening end of the clamp 600. That holds the lower tightening end and the upper tightening end close to each other in a loose position. After the pipe is determined to be in a final position, the screw 620 can be further threaded into the mushroom connector 610 to securely clamp the pipe. Such a final clamped configuration of the clamp 600 is shown in FIG. 7. As the upper clamp component is assembled adjacent the lower clamp component, a diameter “d” of the pipe hanger clamp 600 is also shown.

Those having ordinary skill in the art will appreciate that various other types of multiple position connectors can be used to provide an initial loose position that suspends a pipe but enables longitudinal adjustment of the pipe, and a final tight position that securely clamps a pipe in both vertical and longitudinal directions.

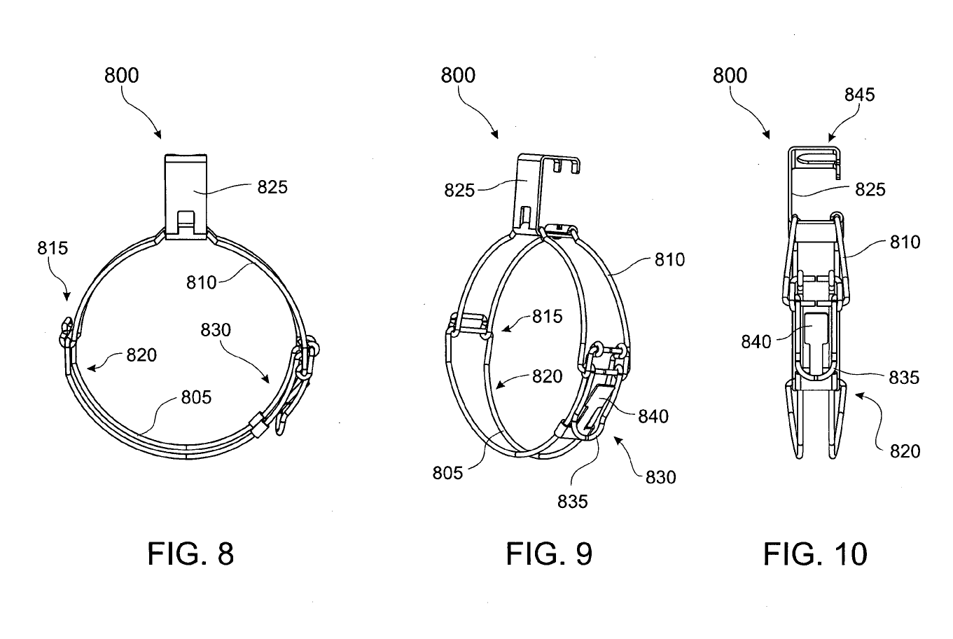

Referring to FIG. 8, a diagram illustrates a rear perspective view of a multiple position pipe hanger clamp 800, according to another alternative embodiment of the present invention. The clamp 800 is similar to the clamp 400; however, the clamp 800 comprises a lower clamp component 805 and an upper clamp component 810 fabricated from bent wire and each comprising an arcuate loop of wire. An upper hinge end 815 is bent into the shape of a hook. That enables a lower hinge end 820 to be “snap fit” into a hinged connection with the upper hinge end 815, as shown.

The clamp 800 also includes a support member 825 for connection to a support such as a threaded rod mounted in a ceiling or joist. Also, a multiple position clamp mechanism 830, in the form of an over-centre buckle, is illustrated in a closed or “tight” position. The over-centre buckle thus functions in essentially two positions, namely a tight position and a loose position. The loose position enables a pipe (not shown) to be supported vertically but adjusted horizontally. The tight position supports a lower tightening end of the lower clamp component 805 tightly adjacent an upper tightening end of the upper clamp component 810, so that the clamp 800 securely grips a perimeter of a section of pipe (not shown).

Referring to FIG. 9, a diagram illustrates a further rear perspective view of the multiple position pipe hanger clamp 800. As shown, the multiple position clamp mechanism 830 in the form of an over-centre buckle includes a handle portion 835 connected both to the lower tightening end of the lower clamp component 805 and to the upper tightening end of the upper clamp component 810. The clamp mechanism 830 further includes a tamper resistant bendable tab 840 that is adapted to be bent, after installation of the clamp 800, to prevent the multiple position clamp mechanism 830 from opening from a tight position to a loose position. The tab 840 thus can be folded over the handle portion 835 to prevent the handle portion 835 from lifting away from the lower tightening end of the lower clamp component 805.

Referring to FIG. 10, a diagram illustrates a side perspective view of the multiple position pipe hanger clamp 800. Here the clamp 800 is shown with the multiple position clamp mechanism 830 facing out of the page. This view further illustrates the support member 825, which includes a forked distal end 845. The forked distal end 845 enables easy attachment of the support member 825 to a support (not shown) such as a threaded rod mounted in a ceiling or joist. For example, such a threaded rod can be placed in the slot formed by the forked distal end 845, and nuts threaded onto such a threaded rod can clamp both sides of the two prongs of the forked distal end 845, thus securing the clamp 800 to the threaded rod.

As will be understood by those having ordinary skill in the art, the clamp 800 can be formed using various types of wire, such as metal wire or polymer wire. For example, conventional wire forming processes can be used to bend a single length of metal wire into the semi-circular shape of the lower clamp component 805. The clamp 800 is thus very environmentally friendly (“green technology”), as significantly less material is used to in the clamp 800 than is used in many alternative clamps.

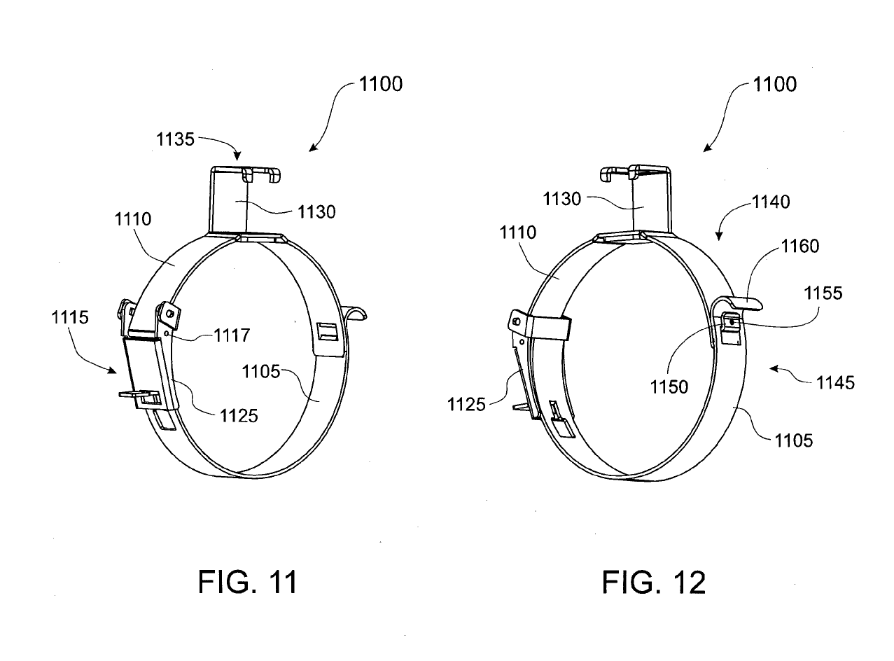

Referring to FIG. 11, a diagram illustrates a front perspective view of a multiple position pipe hanger clamp 1100, according to still another embodiment of the present invention. The clamp 1100 comprises a lower clamp component 1105 and an upper clamp component 1110 fabricated from, for example, sheet metal or hard plastic. A multiple position clamp mechanism 1115, shown in the closed or tight position, supports a lower tightening end of the lower clamp component 1105 tightly adjacent an upper tightening end of the upper clamp component 1110. A pin 1117 connects the upper clamp component 1110 to the multiple position clamp mechanism 1115.

Further, the clamp mechanism 1115 includes a tamper resistant bendable tab 1120 (shown in an unbent configuration) that is adapted to be bent, after installation of the clamp 1100, to prevent the multiple position clamp mechanism 1115 from opening from a tight position to a loose position. As shown, the tab 1120 is cut from the lower clamp component 1105 and extends through a handle portion 1125 of the clamp mechanism 1115. The clamp 1100 also includes a support member 1130 that is similar to the support member 825, including a forked distal end 1135.

Referring to FIG. 12, a diagram illustrates another front perspective view of the multiple position pipe hanger clamp 1100. An upper hinge end 1140 of the upper clamp component 1110 is shown hingedly attached to a lower hinge end 1145 of the lower clamp component 1105. A tab 1150, cut from the upper hinge end 1140, is shown extending through a square hole in the lower hinge end 1145. A button 1155, such as a weld dot, is provided on an inner surface of the tab 1150, which enables the lower hinge end 1145 to be snap fit into a slot between the tab 1150 and the upper hinge end 1140. That prevents the lower hinge end 1145 from easily separating from the upper hinge end 1140.

Further, a distal end of the lower hinge end 1145 is bent to form a tamper resistant bendable tab 1160. After the lower hinge end 1145 is snap fit to the upper hinge end 1140, the tab 1160 can be bent inward toward the tab 1150. That further prevents the lower hinge end 1145 from being easily separated from the upper hinge end 1140.

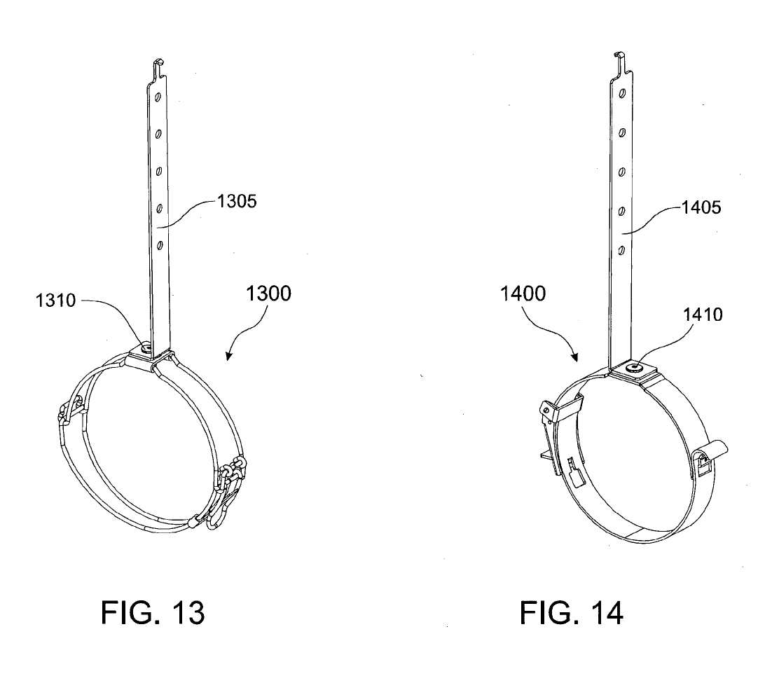

Referring to FIG. 13, a diagram illustrates a front perspective view of a multiple position pipe hanger clamp 1300, according to still another embodiment of the present invention. The clamp 1300 is similar to the clamp 800 shown in FIG. 8; however, the support member 825 has been replaced with a support member 1305 in the form of an elongated strap. For example, the strap can be nailed or screwed to a floor joist. Further, the support member 1305 is rotatably attached to an upper clamp component of the clamp 1300 using a single rivet 1310. That enables the support member 1305 to be easily rotated to align with a flat surface such as a floor joist, without requiring any bending or warping of the support member 1305, and provides a neat finished look to an installed clamp 1300.

Referring to FIG. 14, a diagram illustrates a front perspective view of a multiple position pipe hanger clamp 1400, according to still another embodiment of the present invention. The clamp 1400 is similar to the clamp 1100 shown in FIG. 11; however, the support member 1130 has been replaced with a support member 1405 in the form of an elongated strap. Similar to the configuration shown in FIG. 13, the support member 1405 is rotatably attached to an upper clamp component of the clamp 1400 using a single rivet 1410.

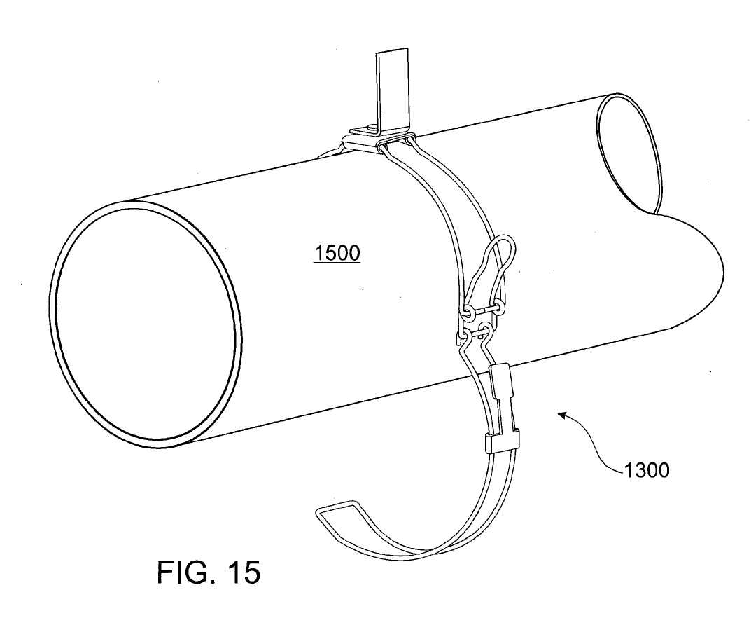

Referring to FIG. 15, a diagram illustrates a perspective view of the multiple position pipe hanger clamp 1300 in an open configuration, and a section of pipe 1500. The clamp 1300 is shown in an open configuration, with the lower hinge end disconnected from the upper hinge end. As shown, that defines an opening 1505 that enables the pipe 1500 (having a diameter approximately equal to the diameter of the assembled upper and lower clamp components) to be inserted into the pipe hanger clamp 1300. To complete installation of the clamp 1300 onto the pipe 1500, the lower clamp component is simply swung upwards so that the lower hinge end snap fits into the upper hinge end. The handle portion of the multiple position clamp mechanism is then pulled downward into a tight position. Finally, the tamper resistant bendable tab is bent downward over the handle portion of the clamp mechanism.

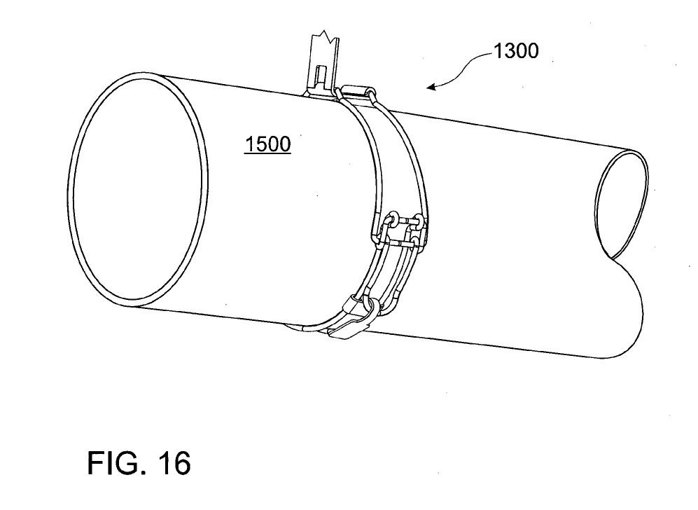

Referring to FIG. 16, a diagram illustrates a perspective view of the multiple position pipe hanger clamp 1300 in a closed configuration around the section of pipe 1500. As shown, the multiple position clamp mechanism is in a tight position, and the tamper resistant bendable tab is bent over the handle portion of the multiple position clamp mechanism.

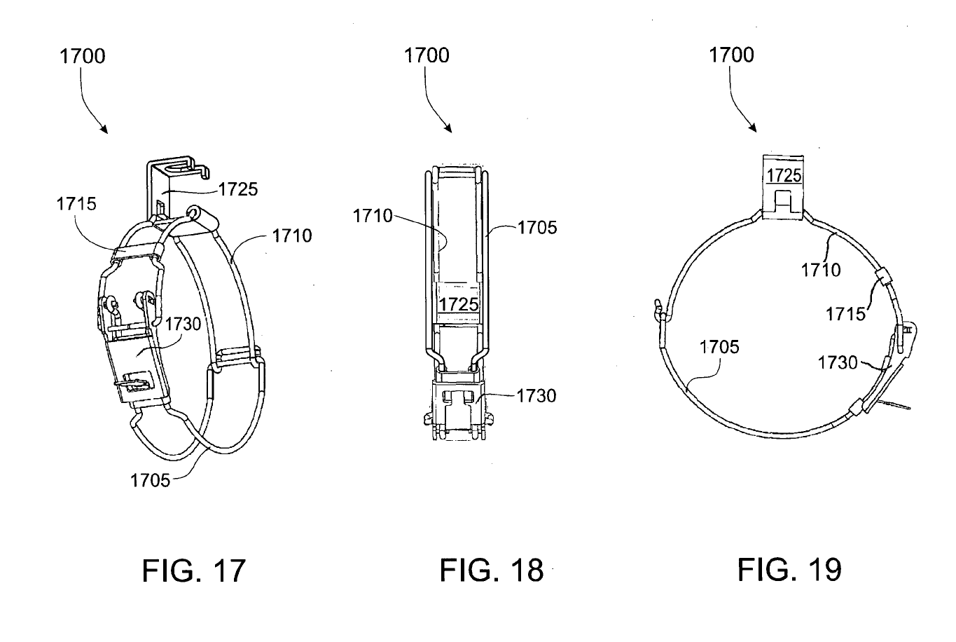

Referring to FIG. 17, a diagram illustrates a side perspective, view of a multiple position pipe hanger clamp 1700, according to another alternative embodiment of the present invention. The clamp 1700 is similar to the clamp 800; however, the clamp 1700 comprises a lower clamp component 1705 and an upper clamp component 1710 fabricated from wire bent into substantially parallel semi-circular arcs. A metal band 1715 is placed around the two wires of the upper tightening end of the upper clamp component 1710 to strengthen and rigidify the component 1710.

The clamp 1700 also includes a support member 1725 for connection to a support such as a threaded rod mounted in a ceiling or joist. Also, a multiple position clamp mechanism 1730, in the form of an over-centre buckle, is illustrated in a closed or “tight” position. Unlike the multiple position clamp mechanism 830 formed from wire, the mechanism 1730 can be formed from sheet steel or another suitable material.

Referring to FIG. 18, a diagram illustrates an underside view of the multiple position pipe hanger clamp 1700. As shown, the wires forming the lower clamp component 1705 and the upper clamp component 1710 are substantially parallel.

Referring to FIG. 19, a diagram illustrates a side view of the multiple position pipe hanger clamp 1700.

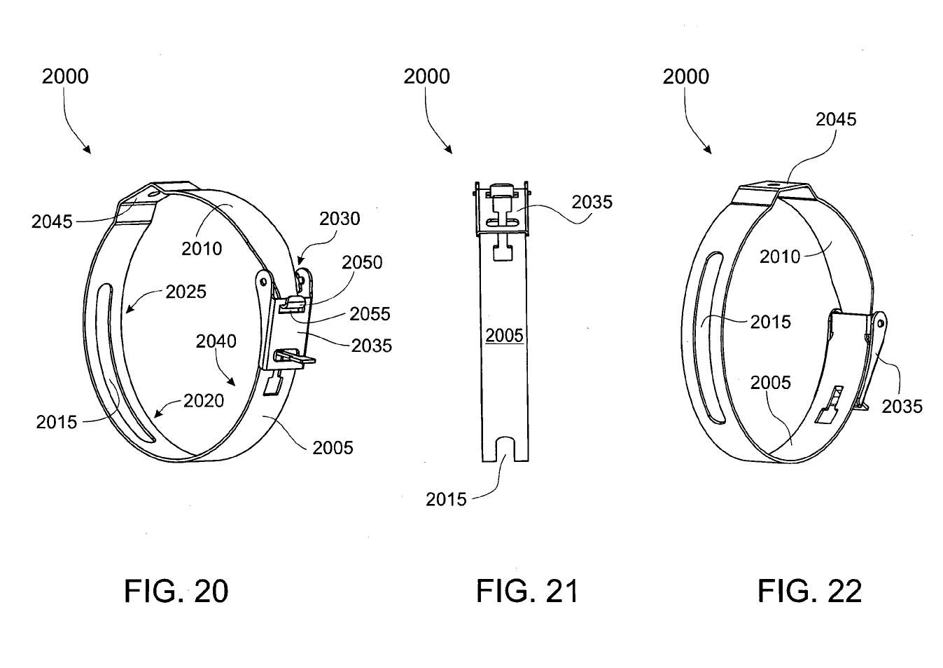

Referring to FIG. 20, a diagram illustrates a side perspective view of a multiple position pipe hanger clamp 2000, according to another alternative embodiment of the present invention. Here, a lower clamp component 2005 and an upper clamp component 2010 are integrally fabricated from a single piece of material such as sheet steel. A slot 2015 is cut into the steel to define a lower hinge end 2020 and an upper hinge end 2025.

When inserting the damp 2000 around a section of pipe, an upper tightening end 2030 is detached from a buckle 2035. The upper tightening end 2030 and a lower tightening end 2040 are then spread apart to fit over the diameter of the pipe, and the lower hinge end 2020 and the upper hinge end 2025 bend elastically to enable adequate separation of the upper tightening end 2030 and a lower tightening end 2040. A top flat section 2045 of the upper clamp component 2010 facilitates attachment of a support member (not shown).

Further, a distal end 2050 of the upper tightening end 2030 of the upper clamp component 2010 is bent and protrudes through a single slot 2055 in the centre of the buckle 2035. That enables the upper clamp component 2010 to be connected to the buckle 2035 without the use of an additional pin such as the pin 1117 shown in FIG. 11.

Referring to FIG. 21, a diagram illustrates an underside view of the multiple position pipe hanger clamp 2000.

Referring to FIG. 22, a diagram illustrates another side perspective view of the multiple position pipe hanger clamp 2000.

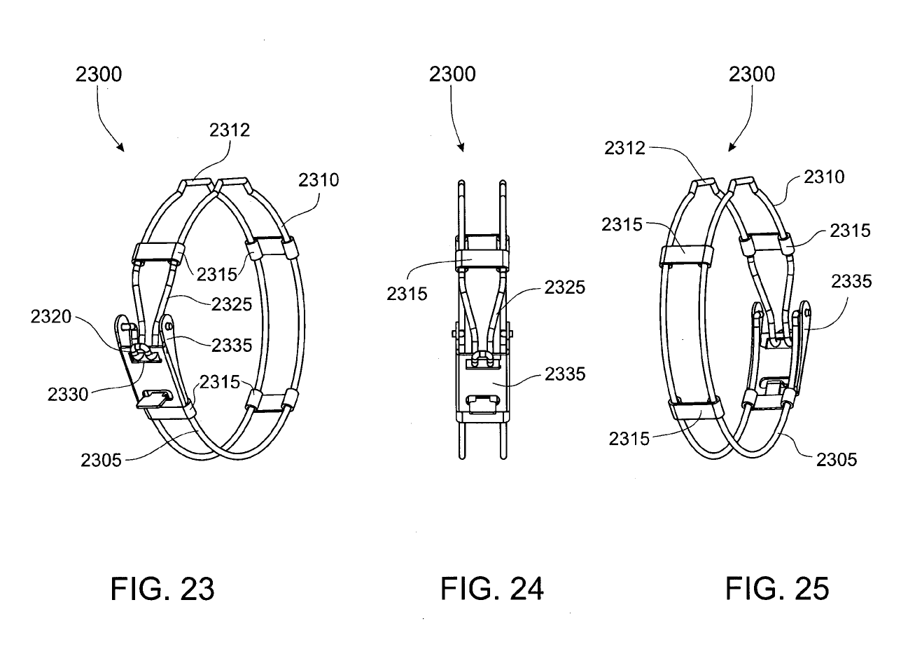

Referring to FIG. 23, a diagram illustrates a side perspective view of a multiple position pipe hanger clamp 2300, according to still another alternative embodiment of the present invention. Here, a lower clamp component 2305 and an upper clamp component 2310 are integrally fabricated from a single length of wire. As shown, the upper clamp component 2310 and the lower clamp component 2305 together comprise a single length of wire bent to define two substantially circular sections that are substantially parallel. A top flat section 2312 of the upper clamp component 2310 facilitates attachment of a support member (not shown).

Four metal bands 2315 are placed around the substantially circular sections of wire at approximately equidistant locations to strengthen and rigidify the components 2305, 2310. Similar to the clamp 2000, a distal end 2320 of an upper tightening end 2325 of the upper clamp component 2310 is bent and protrudes through a single slot 2330 in the centre of a buckle 2335.

Referring to FIG. 24, a diagram illustrates a side view of the multiple position pipe hanger clamp 2300.

Referring to FIG. 25, a diagram illustrates another side perspective view of the multiple position pipe hanger clamp 2300.

According to various embodiments of the present invention, a pipe can be inserted into a pipe hanger clamp either between detached upper and lower tightening ends, or alternatively between detached upper and lower hinge ends. For example, when an upper tightening end is separated from a lower tightening end and a lower hinge end remains connected to an upper hinge end (such as occurs in the embodiments shown in FIGS. 2-7 and FIGS. 20-25), or when an upper hinge end is separated from a lower hinge end and the upper tightening end remains connected to a lower tightening end (such as occurs in the embodiments shown in FIGS. 8-19), an opening is formed that enables a pipe (having a diameter approximately equal to the diameter of the assembled upper and lower clamp components) to be inserted into the pipe hanger clamp. That enables a pipe hanger clamp of the present invention to be installed at a building site—where all fasteners and components of the pipe hanger clamp are attached together—before an associated pipe is secured by the pipe hanger clamp.

Advantages of the present invention thus include an improved pipe hanger clamp design that enables easy assembly by a single worker. A hinge mechanism provides a single point for tightening a pipe in the clamp, and a multiple position clamp mechanism enables a pipe to be suspended in both a loose position that allows for longitudinal pipe adjustment and a final tightened position. Also, as all attachment hardware and fasteners can be secured to the pipe hanger clamp before arriving at a worksite, the risk of losing small fasteners is reduced.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

Limitations in any patent claims should be interpreted broadly based on the language used in the claims, and such limitations should not be limited to specific examples described herein. In this specification, the terminology “present invention” is used as a reference to one or more aspects within the present disclosure. The terminology “present invention” should not be improperly interpreted as an identification of critical elements, should not be improperly interpreted as applying to all aspects and embodiments, and should not be improperly interpreted as limiting the scope of any patent claims.

1. A multiple position pipe hanger clamp, comprising:
a support member;
an upper clamp component attached to the support member, the upper clamp component including a first section extending away from the support member to an upper hinge end and a second section extending away from the support member to an upper tightening end;
a lower clamp component having a lower hinge end and a lower tightening end, wherein when the upper clamp component is assembled adjacent the lower clamp component they define a diameter of the pipe hanger clamp; and
a multiple position clamp mechanism for clamping the lower tightening end to the upper tightening end;
wherein the upper hinge end is hingedly attached to the lower hinge end, and the clamp mechanism is movable between a loose position that supports the lower tightening end loosely adjacent the upper tightening end, and a tight position that supports the lower tightening end tightly adjacent the upper tightening end; and
wherein when the upper tightening end is separated from the lower tightening end and the lower hinge end remains connected to the upper hinge end, or when the upper hinge end is separated from the lower hinge end and the upper tightening end remains connected to the lower tightening end, an opening is formed between the upper tightening end and the lower tightening end, or respectively between the upper hinge end and the lower hinge end, which opening is equal to or greater than the diameter of the pipe hanger clamp.

2. The clamp of claim 1, wherein the upper and lower clamp components comprise wire.

3. The clamp of claim 2, wherein the upper and lower clamp components each comprise an arcuate loop of wire.

4. The clamp of claim 1, wherein the multiple position clamp mechanism comprises an over-centre buckle.

5. The clamp of claim 1, wherein the upper hinge end is slidably removable from the lower hinge end when the upper tightening end is detached from the lower tightening end.

6. The clamp of claim 1, wherein the upper hinge end is slidably removable from the lower hinge end when the clamp mechanism is in a loose position.

7. The clamp of claim 1, wherein the lower clamp component comprises a strap.

8. The clamp of claim 1, wherein the support member comprises a forked distal end.

9. The clamp of claim 1, wherein the support member is rotatably attached to the upper clamp component.

10. The clamp of claim 1, further comprising a tamper resistant bendable tab adapted to be bent, after installation of the pipe hanger clamp, to prevent the upper hinge end from separating from the lower hinge end.

11. The clamp of claim 1, further comprising a tamper resistant bendable tab adapted to be bent, after installation of the pipe hanger clamp, to prevent the multiple position clamp mechanism from opening from the tight position to the loose position.

12. The clamp of claim 1, further comprising a tamper resistant bendable tab adapted to be bent, after installation of the pipe hanger clamp, to prevent the lower hinge end from separating from the upper hinge end.

13. The clamp of claim 1, wherein the upper clamp component and the lower clamp component are each semi-circular.

14. The clamp of claim 1, wherein the upper and lower clamp components comprise sheet metal.

15. The clamp of claim 1, wherein the upper clamp component and the lower clamp component each comprise a single length of wire bent to define two substantially parallel semi-circular arcs.

16. The clamp of claim 1, wherein the upper clamp component and the lower clamp component are integrally fabricated from a single piece of material.

17. The clamp of claim 1, wherein the upper clamp component and the lower clamp component are integrally fabricated from a single length of wire.

18. The clamp of claim 1, wherein a distal end of the upper tightening end of the upper clamp component is bent and protrudes through a single slot in the centre of the multiple position clamp mechanism.

19. The clamp of claim 1, wherein the upper clamp component and the lower clamp component together comprise a single length of wire bent to define two substantially circular sections that are substantially parallel.
